(19) United States
(12) Patent Application Publication
(10) Pub. No.: US 2016/0279783 A1
(43) Pub. Date: Sep. 29, 2016

(54) SPINDLE LOCK ASSEMBLY FOR POWER TOOL

(71) Applicant: BLACK & DECKER INC., New Britain, CT (US)

(72) Inventors: Shihuai Wang, Suzhou (CN); Thomas J. Bodine, Glenwood, MD (US)

(21) Appl. No.: 15/174,660

(22) Filed: Jun. 6, 2016

Related U.S. Application Data
(63) Continuation of application No. PCT/CN2013/090154, filed on Dec. 20, 2013.

(51) Int. Cl. B25F 5/00

(52) U.S. Cl. CPC B25F 5/001

(57) ABSTRACT

A spindle lock assembly (410, 710) for a power tool (10) includes a first rotatable part (904, 704) fixedly connected to an output member (404) of a power tool transmission (16), and a second rotatable part (426, 726) fixedly connected to the power tool output spindle (430) and operatively engaging the first rotatable part. A lock ring (908, 708) surrounds the first and second rotatable parts. The lock ring being is retained in the housing in a substantially stationary manner with a dampener (954, 754) disposed between the lock ring and the power tool housing (772) and to dampen movements of the lock ring relative to the housing in a rotational direction. The spindle lock assembly transmits rotary motion from the transmission output member to the output spindle when the rotary output member is being driven by the motor and inhibits transmittal of rotary motion from the output spindle to the transmission output member when the output spindle is driven by an external force.

### RELATED APPLICATION

This application claims priority, under 35 U.S.C. §120, as a continuation of PCT Application No. PCT/CN2013/090154, filed Dec. 20, 2013, which is incorporated by reference.

### TECHNICAL FIELD

This application relates to a spindle lock assembly for a power tool, such as a power drill or driver.

### BACKGROUND

A spindle lock may be incorporated into a power tool, such as a drill or driver. A spindle lock may be configured to transmit rotary motion from a rotatable output member of a transmission to an output spindle of the power tool when the input member of the transmission is being driven by the motor, and may be configured to prevent or inhibit transmission of rotary motion from the output spindle to the transmission when the output spindle is being driven by an external force (also known as back-driving the transmission). Examples of spindle locks are illustrated in U.S. Pat. Nos. 7,980,324 and 8,205,685, which are incorporated by reference in their entirety.

When the motor is turned on, the motor drives the transmission, which transmits rotary motion through the spindle lock to the output spindle. When the motor is turned off, the motor and transmission decelerate. At the same time, the output spindle still has a great deal of momentum and continues to attempt to rotate relative to the transmission. When the output spindle attempts to rotate, the spindle lock engages to prevent back-driving of the transmission. However, if the motor and transmission rapidly decelerate (e.g., by braking the motor instead of allowing it to coast to a stop), the spindle lock may rapidly engage. This can cause undesirable noise and wear on the spindle lock components. This can also cause rapid deceleration of a tool holder or chuck that is attached to the output spindle, which may result in the tool holder or chuck loosening its grip on an accessory.

### SUMMARY

In an aspect, a power tool includes a housing assembly, a motor received in the housing assembly, an output spindle, and a transmission configured to transmit rotary power between the motor and the output spindle. The transmission includes a rotatable output member. A spindle lock assembly is configured to transmit rotary motion from the rotatable output member to the output spindle when the rotary output member is being driven by the motor and configured to inhibit transmittal of rotary motion from the output spindle to the rotary output member when the output spindle is being driven by an external force. The spindle lock assembly includes a first rotatable part fixedly connected to the output member, a second rotatable part fixedly connected to the output member and operatively engaging with the first rotatable part, and a lock ring surrounding the first rotatable part and the second rotatable part. The lock ring is retained to the housing in a substantially stationary manner with at least one dampener disposed between the lock ring and the housing and configured to dampen movements of the lock ring relative to the housing in a rotational direction.

Implementations of this aspect may include one or more of the following features. The transmission may include a planetary gear transmission having a sun gear, a planet gear, a ring gear, and a carrier that carries the planet gear, where the output member includes the carrier. The first rotatable part may include a plurality of axial lugs extending from the carrier. The second rotatable part may include an anvil fixedly attached to the spindle. The spindle lock assembly may include a plurality of rollers, each roller disposed between adjacent ones of the lugs and between an outer surface of the anvil and an inner surface of the lock ring. The lock ring may include a radially outwardly extending projection received in a recess in the housing, with the dampener disposed between the projection and a sidewall of the recess. The dampener may include a first dampener disposed between the projection and a first sidewall of the recess to dampen movement of the lock ring in a clockwise rotational direction and a second dampener between the projection and a second sidewall of the recess to dampen movement of the lock ring in a counterclockwise rotational direction. The dampener may include an elastomeric plug and/or a spring. The dampener allows for rotational movement of the lock ring relative to the housing by up to approximately 20 degrees, e.g., approximately 2 degrees to approximately 15 degrees or approximately 3 degrees to approximately 17 degrees.

In another aspect, a spindle lock assembly is disclosed for incorporation into a power tool that includes a housing assembly, a motor received in the housing assembly, an output spindle, and a transmission configured to transmit rotary power between the motor and the output spindle. The spindle lock assembly includes a first rotatable part fixedly connected to the transmission, and a second rotatable part fixedly connected to the output spindle and operatively engaging with the first rotatable part. A lock ring surrounds the first rotatable part and the second rotatable part. The lock ring being is retained in the housing in a substantially stationary manner with a dampener disposed between the lock ring and the housing and configured to dampen movements of the lock ring relative to the housing in a rotational direction. The spindle lock assembly is configured to transmit rotary motion from the rotatable output member to the output spindle when the rotary output member is being driven by the motor and is configured to inhibit transmittal of rotary motion from the output spindle to the rotary output member when the output spindle is being driven by an external force.

Implementations of this aspect may include one or more of the following features. The transmission may include a planetary gear transmission having a sun gear, a planet gear, a ring gear, and a carrier that carries the planet gear. The first rotatable part may include a plurality of axial lugs extending from the carrier. The second rotatable part may include an anvil fixedly attached to the spindle. The spindle lock assembly may include a plurality of rollers, each roller disposed between adjacent ones of the lugs and between an outer surface of the anvil and an inner surface of the lock ring. The lock ring may include a radially outwardly extending projection received in a recess in the housing, with the dampener disposed between the projection and a sidewall of the recess. The dampener may include a first dampener disposed between the projection and a first sidewall of the recess to bias movement of the lock ring in a clockwise rotational direction and a second dampener between the projection and a second sidewall of the recess to dampen movement of the lock ring in a counterclockwise rotational direction. The dampener may include at least one of an elastomeric plug and/or a spring. The dampener allows for rotational movement of the lock ring relative to the housing by up to approximately 20 degrees, e.g., approximately 2 degrees to approximately 15 degrees or approximately 3 degrees to approximately 17 degrees.

In another aspect, a power tool includes a housing assembly, a motor received in the housing assembly, an output spindle, and a transmission configured to transmit rotary power between the motor and the output spindle. The transmission includes a rotatable output carrier. A spindle lock assembly is configured to transmit rotary motion from the rotatable output member to the output spindle when the rotary output member is being driven by the motor and configured to inhibit transmittal of rotary motion from the output spindle to the rotary output member when the output spindle is being driven by an external force. The spindle lock assembly includes a plurality of axial lugs fixedly connected to the output carrier, an anvil fixedly connected to the output spindle and operatively engaging with the axial lugs. A lock ring surrounds the axial lugs and the anvil. A plurality of rollers is disposed between adjacent lugs and between an outer surface of the anvil and an inner surface of the lock ring. The lock ring is retained to the housing in a substantially stationary manner by a radially outwardly extending projection received in a recess of the housing. A first dampener is disposed between the projection and a first sidewall of the recess to dampen movement of the lock ring in a clockwise rotational direction and a second dampener disposed between the projection and a second sidewall of the recess to dampen movement of the lock ring in a counterclockwise rotational direction.

Advantages may include one or more of the following. The damped rotational movement of the lock ring will reduce the noise associated with the spindle lock assembly when it is engaged to prevent back-driving of the transmission. The damped rotational movement of the lock ring will also reduce peak deceleration of the output spindle and the attached chuck due to excess momentum in the output spindle when the motor is depowered and/or braked. This will reduce instances of damage to the spindle lock assembly components and reduce instances of the chuck unlocking during deceleration. These and other advantages and features will be apparent from the description, the drawings, and the claims.

### BRIEF DESCRIPTION OF THE DRAWINGS

The drawings described herein are for illustration purposes only and are not intended to limit the scope of the present teachings.

FIG. 1 is a side view of a power tool constructed in accordance with the present teachings.

FIG. 2 is an exploded perspective view of a portion of the power tool of FIG. 1.

FIG. 3 is a more detailed exploded perspective view of a portion of the power tool of FIG. 1.

FIG. 4 is a perspective view of a first embodiment of a spindle lock assembly in accordance with the present teachings.

FIG. 5 is an exploded view of the spindle lock assembly of FIG. 4.

FIG. 6 is a front view of the spindle lock assembly of FIG. 4.

FIG. 7 is a front view of a second embodiment of a spindle lock assembly in accordance with the present teachings.

### DETAILED DESCRIPTION

The following description merely exemplary in nature and is not intended to limit the present teachings, its application, or uses. It should be understood that throughout the drawings corresponding reference numerals indicate like or corresponding parts and features.

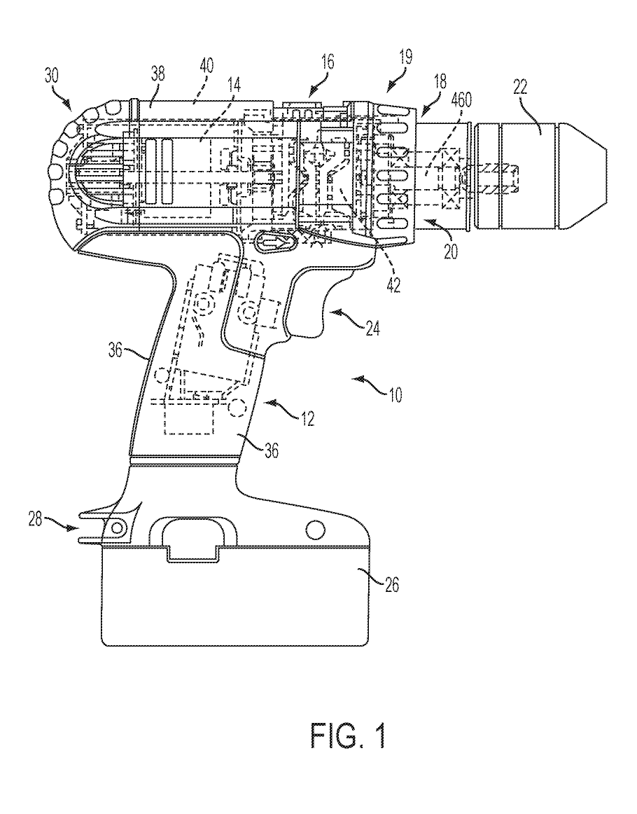

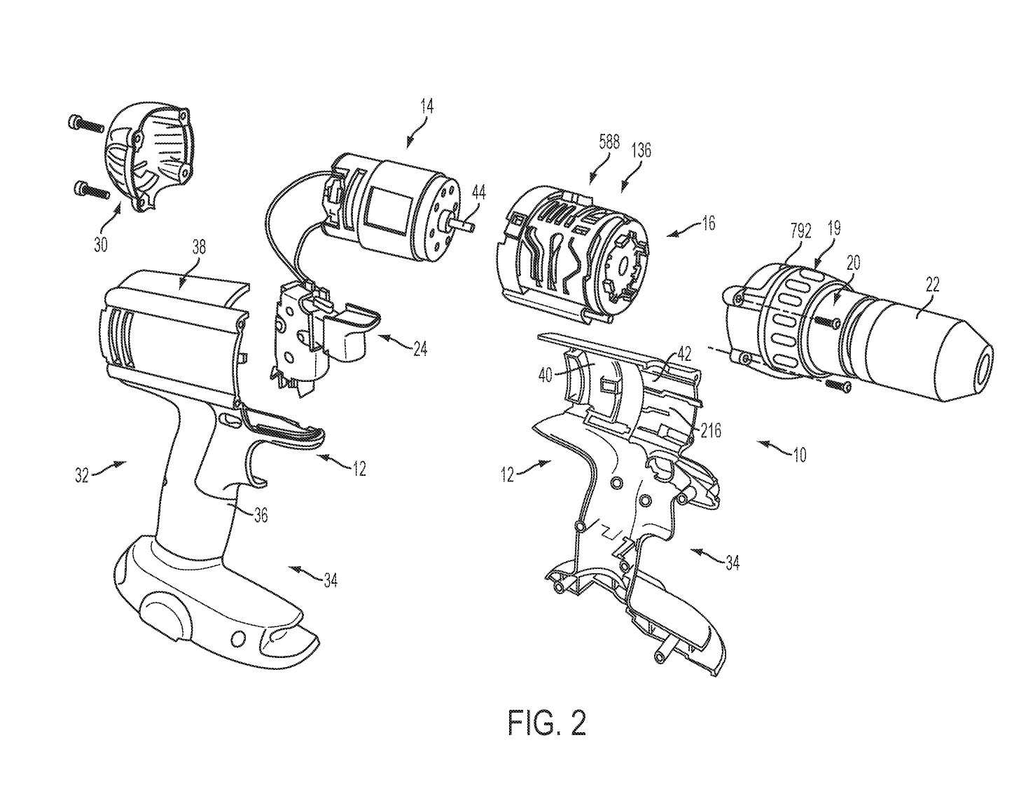

With reference to FIGS. 1 and 2, a power tool constructed in accordance with the present teachings is generally indicated by reference numeral 10. Various aspects of the present teachings may include either a cord or a cordless (battery operated) device, such as a portable screwdriver or a drill (e.g., drill, hammer drill and/or driver). In FIG. 1, the power tool 10 is illustrated as a cordless drill having a housing 12, a motor assembly 14, a multi-speed transmission assembly 16, a clutch mechanism 18, an output spindle assembly 20 (including a hammer mechanism 19, an output spindle housing 772, and an output spindle 430) contained within a spindle housing 21, a chuck 22, a trigger assembly 24, a battery pack 26 and a holder 28. It will be appreciated that a detailed discussion of several of the components of the power tool 10, such as the hammer mechanism 19, the chuck 22, the trigger assembly 24 and the battery pack 26, are outside the scope of the present disclosure. Reference, however, may be made to U.S. Pat. Nos. 6,676,557, 6,857,983, 7,220,211, 7,537,064, 6,984,188, 7,101,300, 6,502,648, and 7,314,097, which are incorporated by reference in their entirety, for an understanding of the operation and/or features that may be included in combination or individually with the power tool 10.

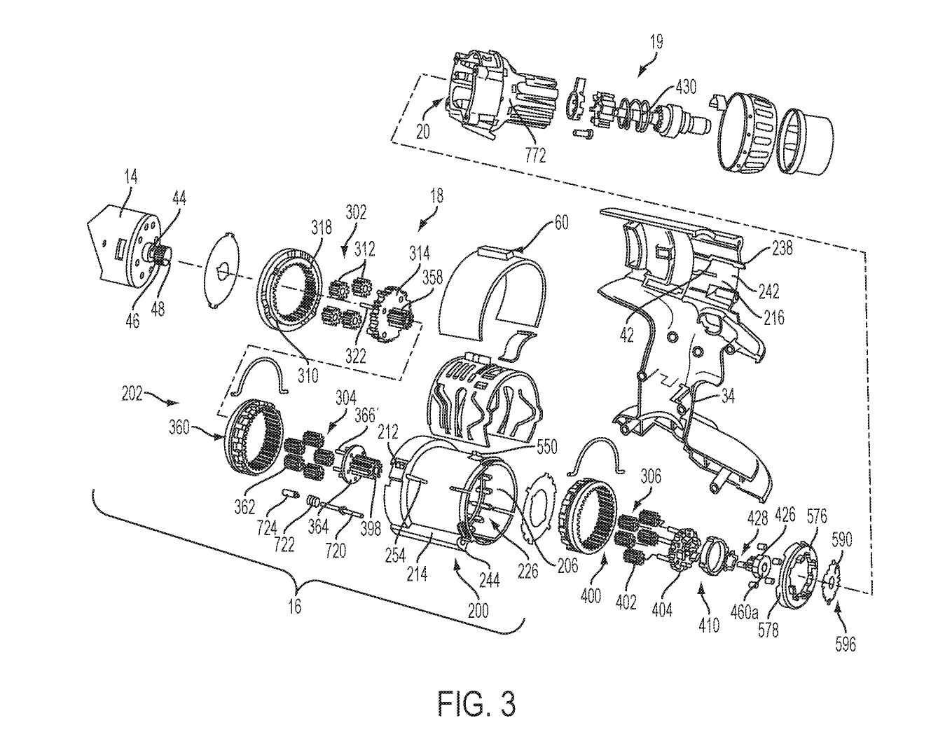

With reference to FIG. 2, the housing 12 may include an end cap assembly 30 and a handle shell assembly 32 that may include a pair of mating handle shells 34. In one aspect, one mating handle shell may be referred to as the assembly side, while the other side may be referred to as the cover side. The handle shell assembly 32 may include a handle portion 36 and a drive train or a body portion 38. The trigger assembly 24 and the battery pack 26 may be mechanically coupled to the handle portion 36 and may be electrically coupled to the motor assembly 14. The body portion 38 may include a motor cavity 40 and a transmission cavity 42. The motor assembly 14 may be housed in the motor cavity 40 and may include a rotatable output shaft 44, which may extend into the transmission cavity 42. A motor pinion 46 having a plurality of gear teeth 48 may be coupled for rotation with the output shaft 44, as illustrated in FIG. 3. The trigger assembly 24 and the battery pack 26 may cooperate to selectively provide electrical power to the motor assembly 14 in a suitable manner to selectively control the speed and/or direction at which output shaft 44 may rotate.

With additional reference to FIG. 3, the transmission assembly 16 may be housed in the transmission cavity 42 and may include a speed selector mechanism 60. The motor pinion 46 may couple the transmission assembly 16 to the output shaft 44 of the motor 14 to transmit a relatively high speed but relatively low torque drive input to the transmission assembly 16. The transmission assembly 16 may include a plurality of reduction elements or reduction gearsets that may be selectively engaged (and disengaged) by the speed selector mechanism 60 to provide a plurality of user-selectable speed ratios. Each of the speed ratios may multiply the speed and the torque of the drive input in a predetermined manner, permitting the output speed and the torque of the transmission assembly 16 to be varied in a desired manner between a relatively low speed but high torque output and a relatively high speed but low torque output. The output from the transmission assembly 16 may be transmitted to the output spindle assembly 20 via a spindle lock assembly 410, as described in greater detail below. The chuck 22 may be incorporated in or coupled for rotation with the output spindle assembly 20 to permit torque to be transmitted to, for example, a tool bit (not shown). The clutch mechanism 18 may be coupled to the transmission assembly 16 and may be operable for limiting the magnitude of the torque associated with the drive input to a predetermined and selectable torque limit.

The transmission assembly 16 may be a three-stage, three-speed transmission that may include a transmission sleeve 200, a reduction gearset assembly 202 and the speed selector mechanism 60. The reduction gearset assembly 202 may include a first reduction gear set 302, a second reduction gear set 304 and a third reduction gear set 306. The first, second and third reduction gear sets 302, 304 and 306 may be operable in an active mode, and the second and third reduction gear sets 304 and 306 may also be operable in an inactive mode, depending on the position of the speed selector mechanism 60. The first reduction gear set 302 may include the motor pinion 46 (which functions as a first sun gear), a first reduction element or the first ring gear 310, a first set of planet gears 312 and a first planet or reduction carrier 314. The first ring gear 310 may be an annular structure, having a plurality of gear teeth 310 a formed along its interior diameter. The first reduction carrier 314 may be formed in the shape of a flat cylinder, having plurality of pins 322 that extend from its rearward face 324 (i.e., toward the motor pinion 46), each carrying one of the planet gears 312. A plurality of gear teeth 314 a may be formed into the outer periphery of the first reduction carrier 314.

The second reduction gear set 304 may be disposed within the portion of the hollow cavity 206 defined by the first housing portion 227 and may include a second sun gear 358, a second reduction element or ring gear 360, a second set of planet gears 362 and a second planet or reduction carrier 364. The second sun gear 358 may be fixed for rotation with the first reduction carrier 314. The second sun gear 358 may include a plurality of gear teeth 358 that may extend forwardly (i.e., away from the motor pinion 46) of the forward face 328 of the first reduction carrier 314. The second ring gear 360 may be an annular structure, having a plurality of gear teeth 360 a formed along an interior surface associated with its inner diameter. The second reduction gearset 304 may include the second reduction carrier 364 having a plurality of pins 366 holding the second set of planet gears 362.

The third reduction gear set 306 may be disposed within the portion of the hollow cavity 206 defined by the second housing portion 229 and may include a third sun gear 398, a third reduction element or ring gear 400, a third set of planet gears 402 and a third planet or reduction carrier 404. The third sun gear 398 may be fixed for rotation with the second reduction carrier 364 and may include a plurality of gear teeth 398 that may be meshingly engaged to the third set of planet gears 402. The third planet carrier 404 may be generally similar to the first planet carrier 314 and may be employed to journal the third set of planet gears 402. The third ring gear 400 may be an annular structure having a plurality of gear teeth 400 a formed along its inner periphery associated with an interior diameter.

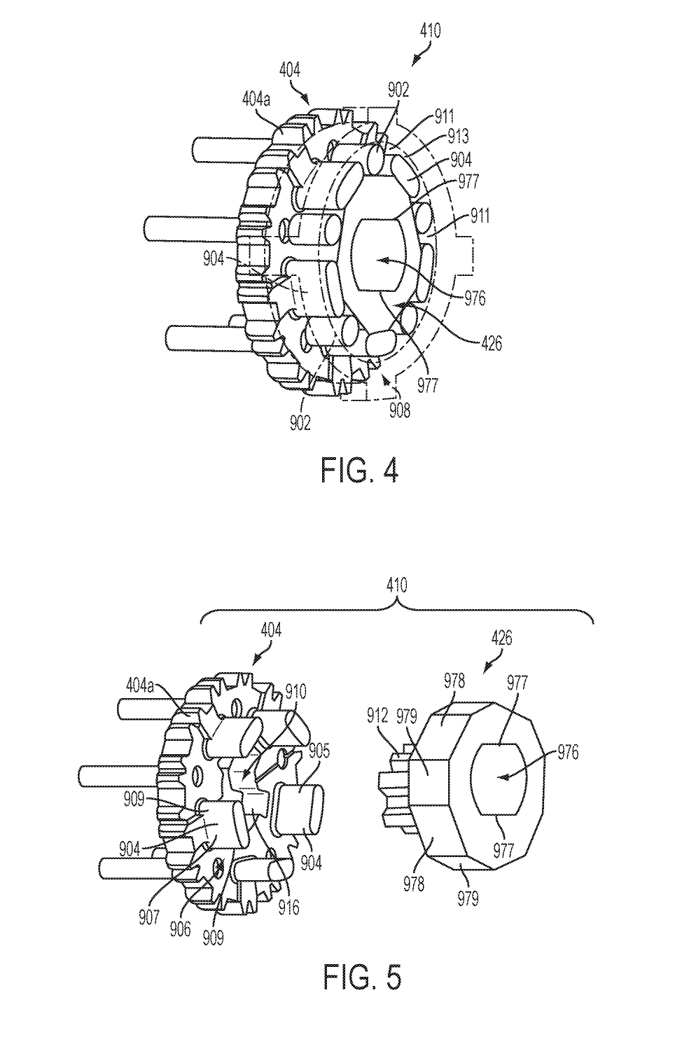

With additional reference to FIGS. 4-6, the spindle lock assembly 410 may include the third (output) stage planet carrier 404 of the transmission, an anvil 426, a plurality of rollers or pins 902, and a lock ring 908. The anvil 426 is fixedly connected to the output spindle 430 by an opening 976 in the anvil having two flat sides 977 so that the anvil 426 and output spindle 430 will rotate together as a unit. The anvil further includes a plurality of alternating cam surfaces 978 and flat surfaces 979 on its periphery. The carrier 404 is fixedly connected to a plurality of lugs 904 that project axially forward from the carrier 404 and that rotate together with the carrier 404. The lugs 904 each have a flat inner surface 905, a flat outer surface 907 and curved end surfaces 909 connecting the flat inner surface 905 and flat outer surface.

As shown in FIGS, 4 and 6, the anvil 426 is received between the lugs 904 so that the anvil 426 and lugs 904 are operatively engaged with the flat inner surfaces 905 abutting the flat outer surfaces 979 of the anvil 426. The lock ring 908 surrounds the anvil 426 and lugs Each of the plurality of pins 902 is freely received in a space or pocket 911 defined between adjacent lugs 904 and between a cam surface 978 of the anvil 426 and an inner surface 913 of the lock ring 908.

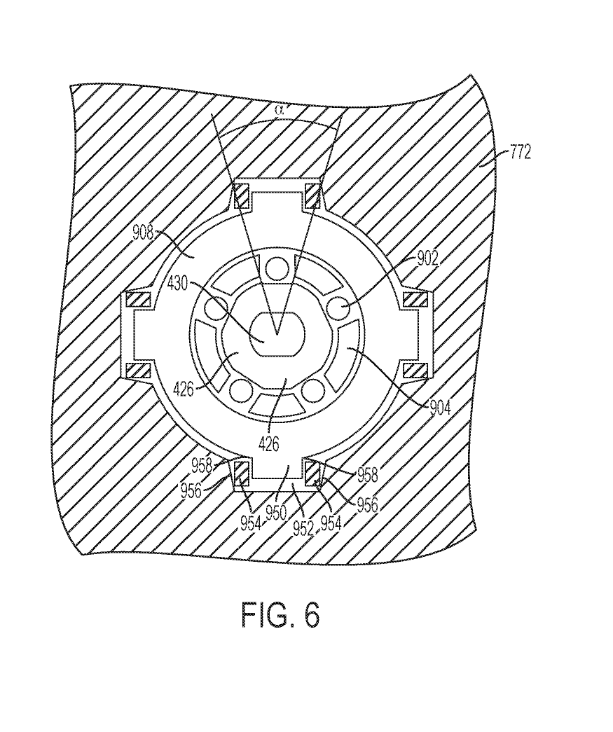

As shown in FIG. 5, the carrier 404 optionally includes a central opening 910 that receives an optional rearward projection 912 on the anvil 426. In the illustrated embodiment, the central opening 910 and the rearward projection 912 each have a polygonal cross-section that mesh with one another to enable a small amount of rotational movement or play between the anvil 426 and carrier 404 (e.g, up to approximately 30 degrees of relative rotation). It should be understood that the shapes of the central opening 910 and rearward projection 912 may be different, e.g., circular, to enable greater, lesser, or unlimited relative rotation between the anvil and carrier. It should also be understood that the central opening 910 and rearward projection 912 may be omitted without departing from the scope of this disclosure.

As shown in FIG. 6, the lock ring 908 is retained in the housing 778 in a substantially stationary manner by a plurality of projections 950 extending radially outward from the lock ring 908. Each projection is received in a corresponding recess 952 in the housing 778. Each recess 952 is slightly wider than the corresponding projection 950 so as to permit a small amount of rotational movement or play between the lock ring 950 and housing 772. The small amount of rotational movement is damped by a plurality of dampeners 954, each received between a sidewall 956 of the recess 952 and a sidewall 958 of the projection 950. In the illustrated embodiment, the dampeners 954 are each composed of an elastomeric (e.g., rubber) plug. This arrangement enables a small amount of damped rotational movement of the lock ring 950 relative to the housing 772. For example, the lock ring may be able to move by an angle a of less than approximately 20 degrees, e.g., between approximately 2 degrees and approximately 15 degrees.

In operation, the lugs 904, the cam surfaces 978 of the anvil 426, and the interior surface 913 of the lock ring 908 work together so that when the output carrier 426 is driven by the motor and transmission, the lugs 904, the rollers 902, and the anvil 426 rotate freely within the lock ring 908, while the lock ring 908 remains stationary, to enable transmission of torque from the output carrier 404 to the spindle 430. When the output spindle 430 is driven by an external force (such as by manual input when the user is tightening or loosening the chuck, or by excess momentum of the output spindle 430 when the motor is braked), the spindle 430 and the anvil 426 rotate together to cause the rollers 902 to be pinched between the inner wall 913 of the lock ring 908, the cam surface 978 of the anvil 426, and the lugs 904 of the output carrier 404, which prevents or inhibits back driving of the transmission.

At the same time, the lock ring will be able to undergo a small, damped rotational movement due to compression of the dampers 954 in either the clockwise or counterclockwise direction. This damped rotational movement will reduce the noise associated with the spindle lock assembly when it is engaged to prevent back-driving of the transmission. This damped rotational movement will also reduce peak deceleration of the output spindle and the attached chuck due to excess momentum in the output spindle when the motor is depowered and/or braked. This will reduce instances of damage to the spindle lock assembly components and reduce instances of the chuck unlocking during deceleration.

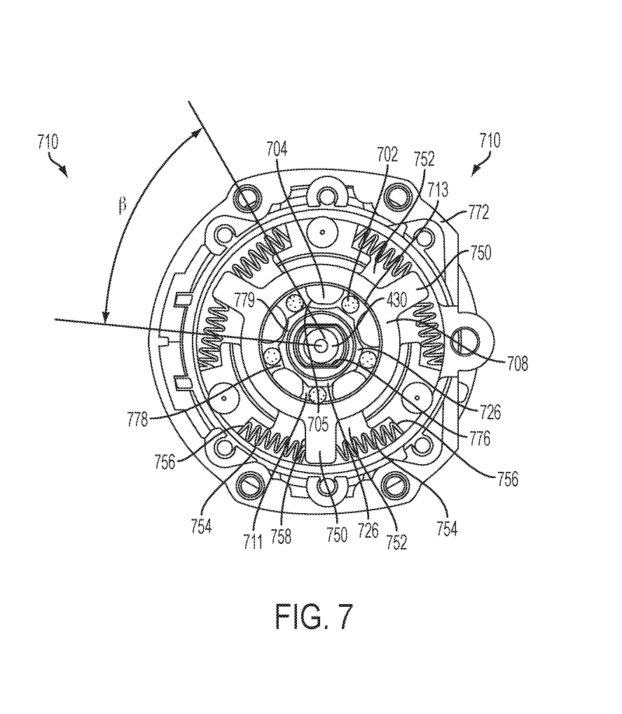

Referring to FIG. 7, in an alternative embodiment, the spindle lock assembly 710 may include the third (output) stage planet carrier 404 of the transmission, an anvil 726, a plurality of rollers or pins 702, and a lock ring 708. The anvil 726 is fixedly connected to the output spindle 430 by an opening 776 in the anvil having two flat sides so that the anvil 726 and output spindle 430 will rotate together as a unit. The anvil further includes a plurality of alternating flat surfaces 778 and concave outer surfaces 779 on its periphery. The carrier 404 is fixedly connected to a plurality of lugs 704 that project axially forward from the carrier 404 and that rotate together with the carrier 404. The lugs 704 each have a convex inner surface 705.

The anvil 726 is received between the lugs 704 so that the anvil 726 and lugs 704 are operatively engaged with the convex inner surfaces 705 abutting the concave outer surfaces 779 of the anvil 726. The lock ring 708 surrounds the anvil 726 and lugs 704. Each of the plurality of pins 702 is freely received in a space or pocket 711 defined between adjacent lugs 704 and between a flat surface 778 of the anvil 726 and an inner surface 713 of the lock ring 708.

The lock ring 708 is retained in the housing 772 in a substantially stationary manner by a plurality of projections 750 extending radially outward from the lock ring 708. Each projection is received in a corresponding recess 752 in the housing 772. Each recess 752 is wider than the corresponding projection 750 so as to permit a small amount of rotational movement or play between the lock ring 750 and housing 772. The small amount of rotational movement is damped by a plurality of dampeners 754, each received between a sidewall 756 of the recess 752 and a sidewall 758 of the projection 750. In the illustrated embodiment, the dampeners 754 are each a compression spring. This arrangement enables a small amount of damped rotational movement of the lock ring 750 relative to the housing 772. For example, the lock ring may be able to move by an angle β of less than approximately 20 degrees, e.g., between approximately 3 degrees and approximately 17 degrees, and more particularly approximately 10 degrees.

In operation, the lugs 704, the flat surfaces 778 of the anvil 726, and the interior surface 713 of the lock ring 708 work together so that when the output carrier 404 is driven by the motor and transmission, the lugs 704, the rollers 702, and the anvil 726 rotate freely within the lock ring 708, while the lock ring 708 remains stationary, to enable transmission of torque from the output carrier 404 to the spindle 430. When the output spindle 430 is driven by an external force (such as by manual input when the user is tightening or loosening the chuck, or by excess momentum of the output spindle 430 when the motor is braked), the spindle 430 and the anvil 726 rotate together to cause the rollers 702 to be pinched between the inner wall 713 of the lock ring 708, the flat surface 778 of the anvil 726, and the lugs 704 of the output carrier 404, which prevents or inhibits back driving of the transmission.

At the same time, the lock ring will be able to undergo a small, damped rotational movement due to compression of the spring dampers 754 in either the clockwise or counterclockwise direction. This damped rotational movement will reduce the noise associated with the spindle lock assembly when it is engaged to prevent back-driving of the transmission. This damped rotational movement will also reduce peak deceleration of the output spindle and the attached chuck due to excess momentum in the output spindle when the motor is depowered and/or braked. This will reduce instances of damage to the spindle lock assembly components and reduce instances of the chuck unlocking during deceleration.

Numerous modifications may be made to the exemplary implementations described above. For example, other spindle lock assembly designs may have different configurations and geometries of the spindle lock components (e.g., number and geometry of rollers and number and geometry of lugs, lock ring, and anvil surfaces). In addition, other types of configurations of dampeners may be used on the lock ring to dampen rotational movement and to soften output spindle deceleration. These and other implementations are within the scope of the following claims.

What is claimed is:

1. A power tool comprising:
a housing assembly;
a motor received in the housing assembly;
an output spindle;
a transmission configured to transmit rotary power between the motor and the output spindle, the transmission including a rotatable output member;
a spindle lock assembly configured to transmit rotary motion from the rotatable output member to the output spindle when the rotary output member is being driven by the motor and configured to inhibit transmittal of rotary motion from the output spindle to the rotary output member when the output spindle is being driven by an external force, the spindle lock assembly including a first rotatable part fixedly connected to the output member, a second rotatable part fixedly connected to the output member and operatively engaging with the first rotatable part, and a lock ring surrounding the first rotatable part and the second rotatable part,
wherein the lock ring is retained to the housing in a substantially stationary manner with at least one dampener disposed between the lock ring and the housing and configured to dampen movements of the lock ring relative to the housing in a rotational direction.

2. The power tool of claim 1, wherein the transmission comprises a planetary gear transmission having a sun gear, a planet gear, a ring gear, and a carrier that carries the planet gear, wherein the output member includes the carrier.

3. The power tool of one of claims 1 and 2, wherein the first rotatable part comprises a plurality of axial lugs extending from the carrier.

4. The power tool of one of claims 1-3, wherein the second rotatable part comprises an anvil fixedly attached to the spindle.

5. The power tool of claim 4, wherein the spindle lock assembly further comprises a plurality of rollers, each roller disposed between adjacent ones of the lugs and between an outer surface of the anvil and an inner surface of the lock ring.

6. The power tool of one of claims 1-5, wherein the lock ring comprises a radially outwardly extending projection received in a recess in the housing, with the dampener disposed between the projection and a sidewall of the recess.

7. The power tool of claim 6, wherein the dampener comprises a first dampener disposed between the projection and a first sidewall of the recess to dampen movement of the lock ring in a clockwise rotational direction and a second dampener between the projection and a second sidewall of the recess to dampen movement of the lock ring in a counterclockwise rotational direction.

8. The power tool of one of claims 1-7, wherein the dampener comprises an elastomeric plug or a spring.

9. The power tool of one of claims 1-8, wherein the dampener allows for rotational movement of the lock ring relative to the housing by up to approximately 20 degrees.

10. The power tool of one of claims 1-9, wherein the dampener allows for the rotational movement of the lock ring relative to the housing by approximately 2 degrees to approximately 15 degrees.

11. The power tool of one of claims 1-9, wherein the dampener allows for the rotational movement of the lock ring relative to the housing by approximately 3 degrees to approximately 17 degrees.

12. A spindle lock assembly for a power tool that includes a housing assembly, a motor received in the housing assembly, an output spindle, and a transmission configured to transmit rotary power between the motor and the output spindle, the spindle lock assembly comprising:
a first rotatable part fixedly connected to the transmission;
a second rotatable part fixedly connected to the output spindle and operatively engaging with the first rotatable part;
a lock ring surrounding the first rotatable part and the second rotatable part, the lock ring being retained in the housing in a substantially stationary manner with a dampener disposed between the lock ring and the housing and configured to dampen movements of the lock ring relative to the housing in a rotational direction,
wherein the spindle lock assembly is configured to transmit rotary motion from the rotatable output member to the output spindle when the rotary output member is being driven by the motor and is configured to inhibit transmittal of rotary motion from the output spindle to the rotary output member when the output spindle is being driven by an external force.

13. The spindle lock assembly of claim 12, wherein:
the transmission comprises a planetary gear transmission having a sun gear, a planet gear, a ring gear, and a carrier that carries the planet gear;
the first rotatable part comprises a plurality of axial lugs extending from the carrier;
the second rotatable part comprises an anvil fixedly attached to the spindle; and
the spindle lock assembly further comprises a plurality of rollers, each roller disposed between adjacent ones of the lugs and between an outer surface of the anvil and an inner surface of the lock ring.

14. The spindle lock assembly of claim one of claims 12 and 13, wherein the lock ring comprises a radially outwardly extending projection received in a recess in the housing, with the dampener disposed between the projection and a sidewall of the recess.

15. The spindle lock assembly of claim 14, wherein the dampener comprises a first dampener disposed between the projection and a first sidewall of the recess to bias movement of the lock ring in a clockwise rotational direction and a second dampener between the projection and a second sidewall of the recess to dampen movement of the lock ring in a counterclockwise rotational direction.

16. The spindle lock assembly of one of claims 12-15, wherein the dampener comprises at least one of an elastomeric plug and a spring.

17. The spindle lock assembly of one of claims 12-16, wherein the dampener allows for rotational movement of the lock ring relative to the housing by up to approximately 20 degrees.

18. A power tool comprising:
a housing assembly;
a motor received in the housing assembly;
an output spindle;
a transmission configured to transmit rotary power between the motor and the output spindle, the transmission including a rotatable output carrier;
a spindle lock assembly configured to transmit rotary motion from the rotatable output member to the output spindle when the rotary output member is being driven by the motor and configured to inhibit transmittal of rotary motion from the output spindle to the rotary output member when the output spindle is being driven by an external force, the spindle lock assembly including a plurality of axial lugs fixedly connected to the output carrier, an anvil fixedly connected to the output member and operatively engaging with the axial lugs, a lock ring surrounding the axial lugs and the anvil, and a plurality of rollers, each roller disposed between adjacent lugs and between an outer surface of the anvil and an inner surface of the lock ring.
wherein the lock ring is retained to the housing in a substantially stationary manner by a radially outwardly extending projection received in a recess of the housing, and further including a first dampener disposed between the projection and a first sidewall of the recess to dampen movement of the lock ring in a clockwise rotational direction and a second dampener disposed between the projection and a second sidewall of the recess to dampen movement of the lock ring in a counterclockwise rotational direction.
